(19) United States
(12) Patent Application Publication
(10) Pub. No.: US 2013/0017348 A1
(43) Pub. Date: Jan. 17, 2013

(54) INVISIBLE ENCLOSURE

(71) Applicant: Atsushi Sanada, Yamaguchi (JP)

(72) Inventor: Atsushi Sanada, Yamaguchi (JP)

(73) Assignee: YAMAGUCHI UNIVERSITY, Yamaguchi-shi, Yamaguchi (JP)

(21) Appl. No.: 13/637,580

(22) PCT Filed: Mar. 24, 2011
(86) PCT No.: PCT/JP2011/057188

§ 371 Date: Sep. 26, 2012

(30) Foreign Application Priority Data
Mar. 26, 2010 (JP) 2010-073063

(51) Int. Cl. B32B 1/08

(52) U.S. Cl. 428/34.1

(57) ABSTRACT

An invisible enclosure includes a cylindrical central enclosure having a cavity formed therein and an outer shell formed of homogenous materials, with an object in the cavity and the central enclosure itself being substantially invisible with an electromagnetic wave. The central enclosure is formed by laminating a large number of cylindrical layered films formed by radially laminating a plurality of materials having different permittivities. Effective values of respective permittivities of respective parts of the central enclosure are adjusted by adjusting permittivities and radial thicknesses of respective layers of the layered films along a radius value of the central enclosure. The radial element of a permittivity tensor is set to be a value sequentially increasing along a radius from the innermost circumference of the central enclosure to the outermost circumference thereof and is set to be a predetermined value smaller than the permittivity of the outer shell at the outermost circumference.

### TECHNICAL FIELD

The present invention relates to an enclosure for making an object invisible or substantially invisible with an electromagnetic wave (including light). More particularly, the present invention relates to an invisible enclosure which constitutes an enclosure capable of enclosing an object, and makes the enclosure itself and an object enclosed by the enclosure is substantially invisible over some frequency range of an electromagnetic wave. Meanwhile, invisibility referred to herein means that a propagation state of an electromagnetic wave after passing through an enclosure and an object is exactly the same as a case in which the object does not exist.

### BACKGROUND ART

An invisible enclosure for making an enclosure itself and an object enclosed by the enclosure is substantially invisible over some frequency range of an electromagnetic wave by enclosing the object by a special enclosure is referred to as a cloak medium and research for realizing the same has been conducted. The invisible enclosure on which research or trial production has been performed before included metamaterials using a resonance phenomenon. Herein, the metamaterials will be first described.

A medium having a property that does not exist in nature may be artificially formed by arranging small pieces (unit structures) of such as a metal, a dielectric substance, a magnetic substance, or a superconductor at sufficiently short intervals (about 1/10 of a wavelength or less) over a wavelength. The medium is referred to as a metamaterial since the medium belongs to wider categories when compared with a category of a medium that exists in nature. The nature of metamaterials may be variously changed by the shape and material of a unit structure and an arrangement thereof.

The art described in the following Patent Document 1 is already known as an artificial magnetic substance of metamaterials. Patent Document 1 describes an artificial magnetic substance using split ring resonators as the prior art and an artificial magnetic substance formed by arranging a pair of conductor pieces facing each other with a dielectric substance interposed therebetween.

When using these metamaterials, it is possible to make the enclosure and any object invisible by the enclosure enclosing the object. The enclosure is referred to as a cloak medium or the like, and realizes a function of a so-called invisibility cloak that makes covered objects invisible.

Further, the invisibility referred herein means that a propagation state of an electromagnetic wave after passing through the enclosure and the object is exactly the same as a case in which the enclosure and the object do not exist. In the invisible state, the electromagnetic wave passing through the enclosure and the object is propagated in the state which is exactly the same as the case in which the enclosure and the object do not exist. Therefore, it is impossible with the electromagnetic wave to detect whether the enclosure and the object exist. That is, the enclosure and the object are not visible at all.

In the present description, the enclosure that can create the invisible state or the invisible state substantially close to the invisible state is referred to as the invisible enclosure. Forming the invisible enclosure of the artificial magnetic substance of the metamaterials is known as described in the following Non-Patent Document 1 or the like. Non-Patent Document 1 describes that the enclosure in which many split ring resonators of non-magnetic metal are arranged in a cylindrical shape creates the substantially invisible state at a specific frequency of an electromagnetic.
Patent Document 1: Japanese Patent Application Laid-Open No. 2008-28010
Non-Patent Document 1: D. Schurig, J. J. Mock, B. J. Justice, S. A. Cummer, J. B. Pendry, A. F. Starr, D. R. Smith,“Metamaterial electromagnetic cloak at microwave frequencies”, Science Express, Manuscript Number 113362, 2006

The invisible enclosure described in Non-Patent Document 1 includes the artificial magnetic substance using split ring resonators of metals. Further, the frequency for the invisible characteristics is near to a resonance frequency of the split ring resonator. Therefore, there is a problem in that the frequency range for the invisible characteristics is determined in an extremely limited range near the resonance frequency. That is, a band of the frequency for the invisible characteristics becomes very narrow. Further, there is a problem in that a loss due to metal largely appears near the resonance frequency and a loss of the invisible enclosure is increased accordingly. When the loss of the invisible enclosure is increased, the invisible characteristics are damaged.

### DISCLOSURE OF THE INVENTION

Therefore, the present invention is directed to a broadband and low-loss invisible enclosure capable of realizing invisible characteristics in an extremely wider band than a conventional art by forming an invisible enclosure by the simple structure of ordinary media materials, without using a medium using a resonance phenomenon or metamaterials having a complex structure.

In order to achieve the above object, an invisible enclosure according to the present invention includes: a cylindrical central enclosure having a cavity formed therein; and an outer shell disposed to enclose an outside of the central enclosure, with an object in the cavity and the central enclosure itself being substantially invisible with an electromagnetic wave, wherein the central enclosure is formed by laminating a large number of cylindrical layered films formed by radially laminating a plurality of materials having different permittivities so that central lines of the layered films are common, and effective values of respective elements of permittivity tensors of respective parts of the central enclosure are adjusted by adjusting permittivities and radial thicknesses of respective layers of the layered films along a distance from the central line of the central enclosure, that is, a radius.

According to the abovementioned invisible enclosure, the radial element of the permittivity tensor may be set to be a value sequentially increasing along a radius from the innermost circumference of the central enclosure to the outermost circumference thereof and may be set to be a predetermined value smaller than the permittivity of the outer shell at the outermost circumference thereof and the circumferential element of the permittivity tensor may be set to be a substantially constant value, thereby making it possible to realize invisible characteristics.

According to the abovementioned invisible enclosure, the layered film may be a double-layered film configured of two layers, and permittivity of one of the two layers may be set to be a constant value.

According to the abovementioned invisible enclosure, the layered film may be a triple-layered film configured of three layers, and permittivities of the three layers may be set to be a constant value. In addition, a permittivity distribution may be realized by adjusting the thicknesses of three layers.

According to the abovementioned invisible enclosure, the radial element of the permittivity tensor may be set to be the value sequentially increasing along a radius from the innermost circumference of the central enclosure to the outermost circumference thereof and may be set to be a predetermined value smaller than the permittivity of the outer shell at the outermost circumference thereof and the circumferential element of the permittivity tensor may be set to be a value sequentially reducing along the radius from the innermost circumference thereof to the outermost circumference thereof, thereby making it possible to realize the invisible characteristics.

Moreover, an invisible enclosure according to the present invention, includes: a cylindrical central enclosure having a cavity formed therein; and an outer shell disposed to enclose an outside of the central enclosure, with an object in the cavity and the central enclosure itself being substantially invisible with an electromagnetic wave, wherein the central enclosure is formed by laminating a large number of cylindrical layered films formed by radially laminating a plurality of materials having different permeabilities so that central lines of the layered films are common, and effective values of respective elements of permeability tensors of respective parts of the central enclosure are adjusted by adjusting permeabilities and radial thicknesses of respective layers of the layered films along a distance from the central line of the central enclosure, that is, a radius.

According to the abovementioned invisible enclosure, the radial element of the permeability tensor may be set to be a value sequentially increasing along a radius from the innermost circumference of the central enclosure to the outermost circumference thereof and may be set to be a predetermined value smaller than the permeability of the outer shell at the outermost circumference thereof and the circumferential element of the permeability tensor may be set to be a substantially constant value, thereby making it possible to realize invisible characteristics.

According to the abovementioned invisible enclosure, the layered film may be a double-layered film configured of two layers, and permeability of one of the two layers may be set to be a constant value.

According to the abovementioned invisible enclosure, the layered film may be a triple-layered film configured of three layers, and permeabilities of the three layers may be set to be a constant value. In addition, a permeability distribution may be realized by adjusting the thicknesses of three layers.

According to the abovementioned invisible enclosure, the radial element of the permeability tensor may be set to be the value sequentially increasing along a radius from the innermost circumference of the central enclosure to the outermost circumference thereof and may be set to be a predetermined value smaller than the permeability of the outer shell at the outermost circumference thereof and the circumferential element of the permeability tensor may be set to be a value sequentially reducing along the radius from the innermost circumference thereof to the outermost circumference thereof, thereby making it possible to realize the invisible characteristics.

According to the abovementioned invisible enclosure, the outer shell may be preferably formed of homogenous materials.

The present invention has the above configuration and therefore, has the following advantageous effects.

The invisible enclosure can be formed by the simple structure of ordinary media materials, without using a medium using a resonance phenomenon or metamaterials having a complex structure. The invisible enclosure can realize the invisible characteristics in an extremely wider band than a conventional art since the invisible enclosure does not use a resonance phenomenon. Moreover, it is possible to realize the broadband and low-loss invisible enclosure since there is no loss due to a resonance phenomenon.

### BRIEF DESCRIPTION OF THE DRAWINGS

FIG. 1 is a perspective view showing a configuration of an invisible enclosure 1.

FIG. 2 is a diagram showing a value of permittivity and permeability necessary for the invisible enclosure 1.

FIG. 3 is a perspective view showing a configuration of an invisible enclosure 1a according to the present invention.

FIG. 4 is a diagram showing a configuration of a layered film 3 having a two-layer structure of two kinds of dielectric substances.

FIG. 5 is a diagram showing a configuration of a layered film 4 having a three-layer structure of three kinds of dielectric substances.

FIG. 6 is a perspective view showing a unit cylinder 7 formed by the layered film having the two-layer structure.

FIG. 7 is a perspective view showing a configuration of a central enclosure 11 in which the unit cylinders 7 are laminated.

FIG. 8 is a view showing a scattering state of an electromagnetic wave due to a metal rod.

FIG. 9 is a view showing a state of an electromagnetic wave when an invisible enclosure is disposed.

FIG. 10 is a diagram showing a configuration of a layered film 5 having a two-layer structure of two kinds of magnetic substances.

FIG. 11 is a diagram showing a configuration of a layered film 6 having a three-layer structure of three kinds of magnetic substances.

FIG. 12 is a diagram showing a distribution of permittivity and permeability of a medium depending on Formula 2.

FIG. 13 is a diagram showing a distribution of permittivity and permeability of a medium depending on Formula 9.

### BEST MODE FOR CARRYING OUT THE INVENTION

First, a theoretical basis of the present invention will be described. In cylindrical coordinate system (r, θ, z) based on a radius r, an azimuth θ, and a position z in a z-axis direction, coordinate transformation is performed based on the following Formula 1 so as to transform a region in which 0≦r≦b into a ring-shaped region (r′, θ′, z′) in which a≦r′≦b.

$${r}^{′} = a + \frac{b - a}{b} r , {θ}^{′} = θ , {z}^{′} = z \qquad [ Formula 1 ]$$

By the coordinate transformation, each element of a permittivity tensor and a permeability tensor becomes as shown in following Formula 2. However, in order to simplify the representation of the formula, a coordinate system (r′, θ′, z′) is changed to be reset to a coordinate system (r, θ, z). Meanwhile, a subscript represents elements of the coordinate direction and each element is represented by relative permittivity and relative permeability.

$${ɛ}_{r} = {μ}_{r} = \frac{r - a}{r} , {ɛ}_{θ} = {μ}_{θ} = \frac{r}{r - a} , \\ {ɛ}_{z} = {μ}_{z} = {( \frac{b}{b - a} )}^{2} \frac{r - a}{r} \qquad [ Formula 2 ]$$

The ring-shaped region by the medium represented by the above Formula 2 has complete invisible characteristics. However, since so many elements are changed depending on a radius r among the elements of the permittivity tensor and the permeability tensor, the medium represented by Formula 2 can hardly realize the values of the elements. Now, for simplification, a direction of a magnetic field of an incident wave is set to be a z-axis direction. In this case, a propagation of an electromagnetic wave is associated with only μ_{z}, ∈ᵣ, and ∈_{θ}. Now, a medium having dispersability represented by Formula 3 will be considered.

$${μ}_{z} = {( \frac{b}{b - a} )}^{2} , {ɛ}_{r} = {( \frac{r - a}{r} )}^{2} , {ɛ}_{θ} = 1 \qquad [ Formula 3 ]$$

The medium of Formula 3 has the same dispersion characteristics as the medium of Formula 2. However, the incident wave to the medium of Formula 3 is not completely anti-reflected, and therefore slightly reflected. This shows that when the slight reflection is permitted, the medium can have invisible characteristics by a control of only the radial element ∈ᵣ of the permittivity tensor. That is, the medium of Formula 3 may have the same trace of penetrating waves as the medium of Formula 2 by controlling only the element ∈ᵣ of the permittivity tensor.

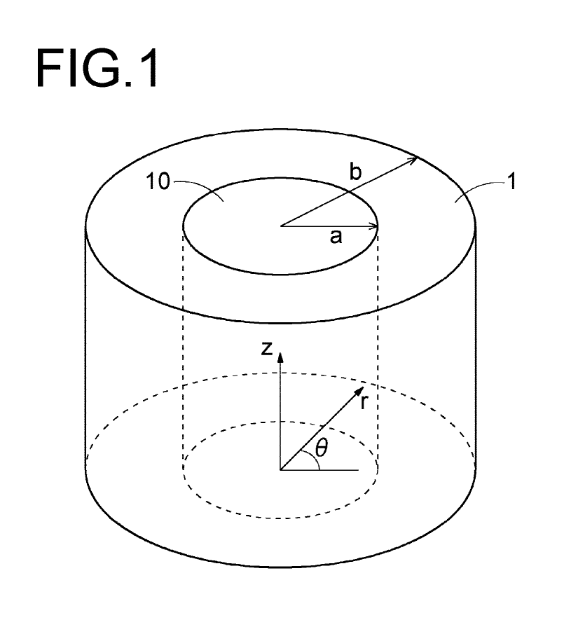

FIG. 1 shows an invisible enclosure 1 as the medium of the ring-shaped region. The invisible enclosure 1 is a cylindrical body having an inner diameter 2a and an outer diameter 2b and a central portion thereof is provided with a cavity 10 and is infinitely present in a central-axis direction. When a central axis of the invisible enclosure 1 is set to be a z axis and a radial direction is set to be an r axis, the medium configuring the invisible enclosure 1 is in a range of a≦r≦b. The region of r<a is the cavity 10. When the invisible enclosure 1 has the complete invisible characteristics, an object in the cavity 10 of r<a is completely hidden and thus, may be invisible.

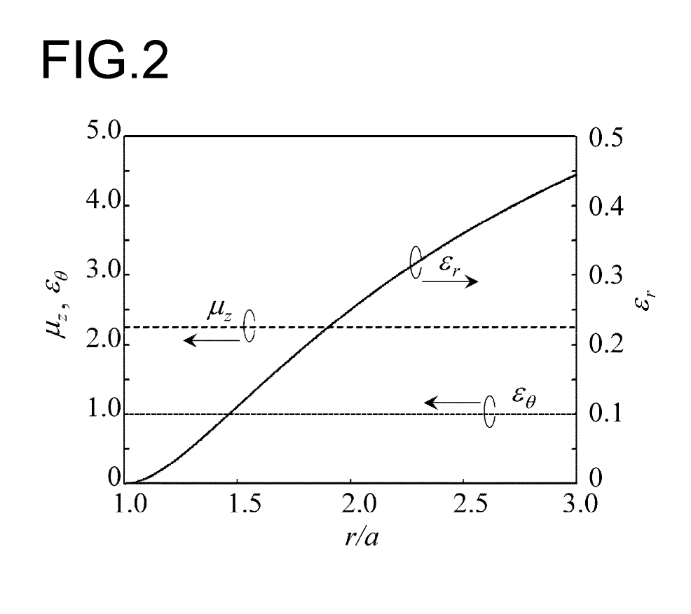

As an example, the permittivity and the permeability necessary for the invisible enclosure 1 in case of a:b=1:3 are calculated from Formula 3. FIG. 2 is a theoretical value of the permittivity and the permeability obtained from Formula 3. A horizontal axis of FIG. 2 represents a value of r/a and a vertical axis represents the relative permittivity and the relative permeability. The values of the permeability μ_{z} and the permittivity ∈_{θ} are constant values regardless of positions in the invisible enclosure 1. The value of the permittivity ∈ᵣ is changed from 0 to about 0.45 in the range of a≦r≦b.

It can be appreciated from Formula 3 that ∈ᵣ=0 at the innermost circumference (r=a) of the invisible enclosure 1 and ∈ᵣ=4/9 at the outermost circumference (r=3a) thereof. As described above, the value of the permittivity ∈ᵣ is set to be 0 at the innermost circumference and is set to be a predetermined value smaller than 1 at the outermost circumference. Meanwhile, the value of ∈ᵣ at the outermost circumference is set to be the value from Formula 3 in which r=b and is defined by a ratio of the inner diameter to the outer diameter.

In addition, as shown in FIG. 2, when the values of elements of the permittivity and permeability tensor are set, the invisible characteristics may be allocated to the invisible enclosure 1. The value of FIG. 2 is obtained based on Formula 3. In addition, when the value of the permittivity ∈ᵣ of the innermost circumference of the invisible enclosure 1 is not set to be exactly 0 but set to be a sufficiently small value, it can be appreciated that considerably good invisible characteristics can be obtained.

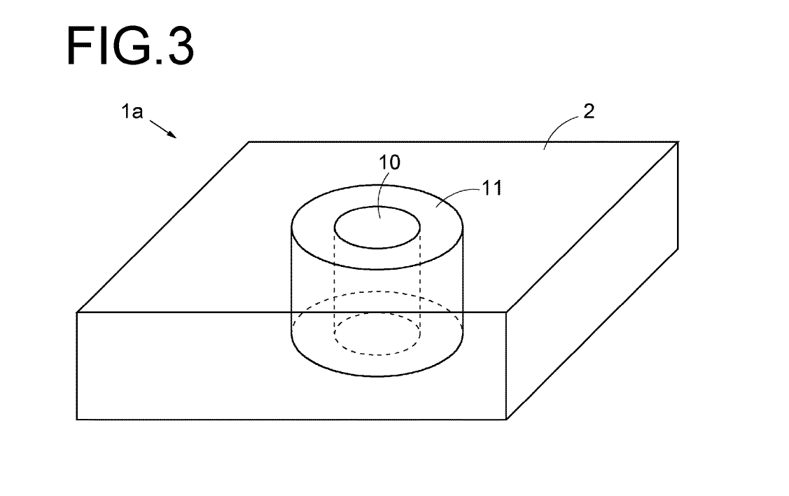

Here, a structure as shown in FIG. 3 is considered in order to realize the invisible enclosure of ordinary media.

FIG. 3 is a diagram showing a configuration of an invisible enclosure 1a according to the present invention. An outer shell 2 of a uniform homogeneous material is disposed at the outside of the central enclosure 11 corresponding to the invisible enclosure 1 of FIG. 1. A central portion of the central enclosure 11 is formed as the cavity 10. In addition, the outer shell 2 is formed of the homogenous material, but the material may be uniformly distributed with fine structures such as bubbles, slits or the like if the structures are sufficiently smaller than a wavelength of the passed-through electromagnetic wave.

When a medium having a sufficiently large permittivity is disposed as the outer shell 2, a distribution of the permittivity inside the central enclosure 11 may be set to be values in proportion thereto. That is, the distribution of the permittivity as shown in FIG. 2 may represent ratios of permittivities of the central enclosure 11 to an external permittivity. Therefore, when the permittivity of the outer shell 2 is large, the permittivity inside the central enclosure 11 is set to be a large value in proportion thereto. When the relative permittivity of the outer shell 2 is set to be ∈ₑ, the permittivity ∈ᵣ inside the central enclosure 11 may be permitted if the value of the ratio ∈ᵣ/∈ₑ has the same distribution as ∈ᵣ of FIG. 2. The permittivity inside the central enclosure 11 may be realized as the ordinary dielectric substance by disposing the outer shell 2.

In the invisible enclosure 1 of FIG. 1, there is a need to use a magnetic material (permeability μ≠1) in order to realize the permeability μ_{z} of Formula 3. When using the non-magnetic material (permeability μ=1) instead of using the magnetic material, reflection is increased at a boundary surface between the outside and the invisible enclosure 1. In the invisible enclosure 1a of FIG. 3, the reflection at the boundary surface between the outer shell 2 and the central enclosure 11 is removed by adjusting the permittivity of the outer shell 2, thereby making the magnetic material unnecessary. In detail, when the relative permittivity ∈ₑ of the outer shell 2 is set to be ∈_{θ}·(1−a/b)², they are matched with each other, such that the reflection is removed at the boundary surface between the outer shell 2 and the central enclosure 11. That is, even though the magnetic material is not used, the reflection at the boundary surface between the outer shell 2 of the invisible enclosure 1a and the central enclosure 11 may be equivalent to the invisible enclosure 1 of FIG. 1 using the magnetic material.

Further, when the outer shell 2 is not disposed, as the dielectric substance inside the enclosure, the medium having the relative permittivity of 1 or less is required as shown in FIG. 2 and the metamaterials or the like using the resonance phenomenon are essentially required. In the invisible enclosure 1a of the present invention, the metamaterials or the like using the resonance phenomenon are not required because the outer shell 2 is disposed. The metamaterials using the resonance phenomenon require the fine metal patterns or other resonance structures and the structure of the metamaterials is complicated, and thus the manufacturing cost is also increased. In the present invention, the invisible enclosure may be realized by the relatively simple structure of the ordinary medium.

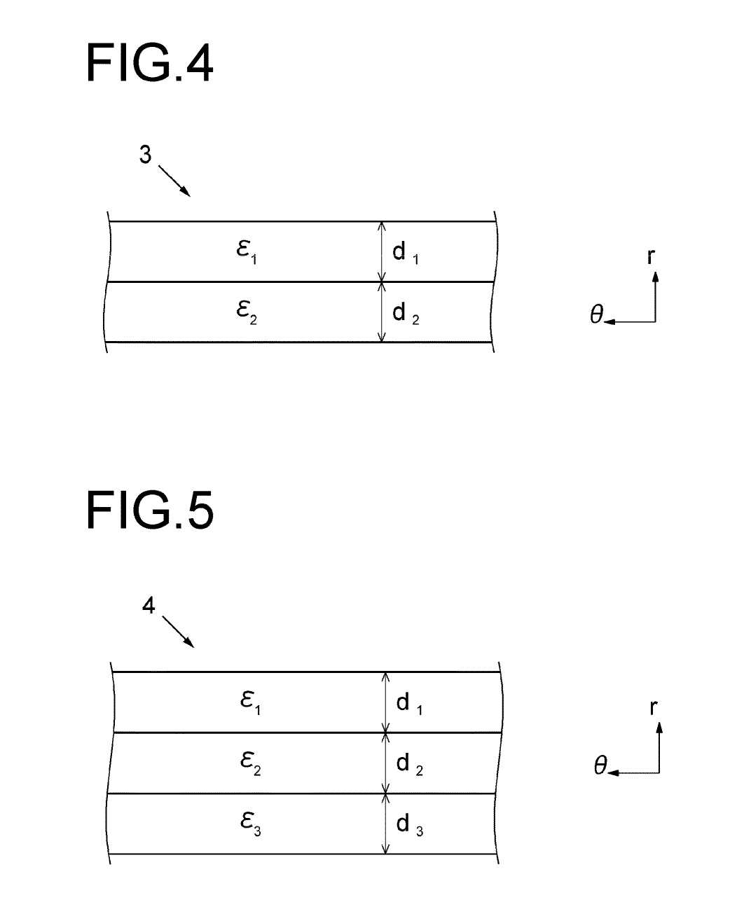

Next, as the configuration for realizing the permittivity distribution inside the central enclosure 11, as shown in FIGS. 4 and 5, the layered structure of plural layers having different permittivities will be considered. FIG. 4 shows a layered film 3 having a two-layer structure of two kinds of dielectric substances and FIG. 5 shows a layered film 4 having a three-layer structure of three kinds of dielectric substances. Herein, when a direction in which a plurality of layers is stacked is a radius r direction of the central enclosure 11 and a direction orthogonal to the radius r direction is an azimuth θ direction, the effective permittivity ∈ᵣ(eff) in the r direction and the effective permittivity ∈_{θ} (eff) in the θ direction in the layered film 3 having the two-layer structure of FIG. 4 may be calculated by the following formulae.

(d₁+d₂)/∈ᵣ(eff)=d₁/∈₁+d₂/∈₂

(d₁+d₂)∈_{θ}(eff)=d₁∈₁+d₂∈₂

Herein, as shown in FIG. 4, the layered film 3 is formed by laminating a layer having the permittivity of ∈₁ and the thickness of d₁ and a layer having the permittivity of ∈₂ and the thickness of d₂. By this configuration, it is possible to change the permittivity ∈ᵣ(eff) while maintaining the permittivity ∈_{θ}(eff) at a constant value by changing the permittivities ∈₁ and ∈₂ and the thicknesses d₁ and d₂. Further, even if the one permittivity (for example, permittivity ∈₁) is a constant value (for example, permittivity of air), it is possible to change the permittivity ∈ᵣ(eff) while maintaining the permittivity ∈_{θ}(eff) at a constant value. Even for the thicknesses d₁ and d₂, more conditions may be added. For example, the overall thickness of the layered film 3 may be constant.

Further, in changing the permittivities of ∈₁ and ∈₂ of the layered film 3, a method of changing the effective permittivity by configuring each layer of the dielectric substance including micro bubbles and changing a density of the bubbles may be considered. The fine slits or micro holes may be used instead of the bubbles. Further, only the permittivity of one layer of the layered film 3 may be changed and the permittivity of the remaining one layer may be a constant value.

Next, in the layered film 4 having the three-layer structure of FIG. 5, the effective permittivity ∈ᵣ(eff) in the r direction and the effective permittivity ∈_{θ}(eff) in the θ direction may be calculated by the following formulae. Herein, as shown in FIG. 5, the layered film 4 is formed by laminating the layer having the permittivity ∈₁ and the thickness d₁, the layer having the permittivity ∈₂ and the thickness d₂, and a layer having a permittivity ∈₃ and a thickness d₃.

(d₁+d+d₃)/∈ᵣ(eff)=d₁/∈₁+d₂/∈₂+d₃/∈₃

(d₁+d+d₃)∈_{θ}(eff)=d₁∈₁+d₂∈₂+d₃∈₃

Therefore, it is possible to change the permittivity ∈ᵣ(eff) while maintaining the permittivity ∈ₑ(eff) at a constant value by changing the permittivities ∈₁ to ∈₃ and the thicknesses d₁ to d₃. In the case of the layered film 4 having a three-layer structure, it is possible to change only the thicknesses d₁ to d₃ without changing the permittivities of all the layers and change the permittivity ∈ᵣ(eff) while maintaining the permittivity ∈_{θ}(eff) at a constant value. Even for the thicknesses d₁ to d₃, more conditions may be added. For example, the overall thickness of the layered film 4 may be constant.

In the case of the layered film 4, it is possible to relatively simply realize the necessary permittivity distribution by changing only the thicknesses of each layer without changing the permittivities of each layer. The manufacturing cost of the invisible enclosure 1a can be reduced by changing only the thicknesses of each layer.

In addition, like the layered film shown in FIGS. 4 and 5, it is possible to change the permittivity ∈ᵣ(eff) while maintaining the permittivity ∈_{θ}(eff) at a constant value, by changing the permittivities and the thicknesses of each layer even in the case of the multi-layered film having more layers. A unit cylinder is formed by forming the layered film 3 having a two-layer structure, the layered film 4 having a three-layer structure, and the multi-layered film having more layers in a cylindrical shape.

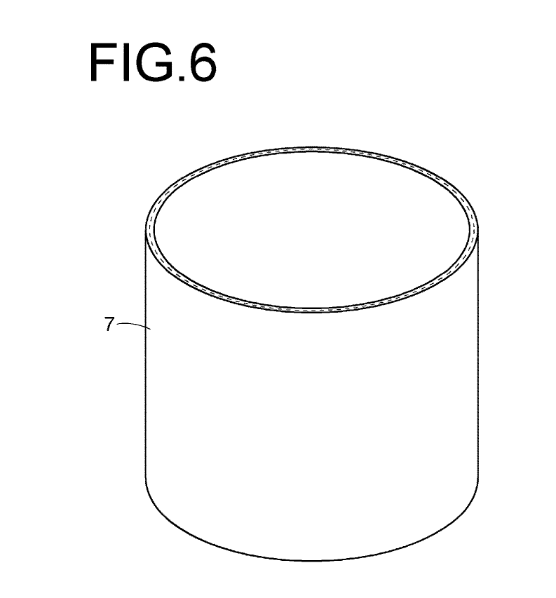

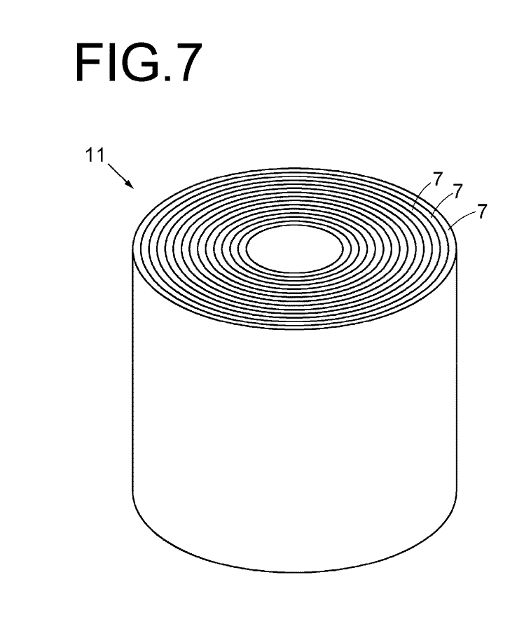

FIG. 6 is a perspective view showing unit cylinders 7 formed by the layered film 3 having a two-layer structure. The central enclosure 11 is formed by manufacturing a large number of unit cylinders having different diameters and permittivities ∈ᵣ(eff) as the unit cylinders 7 and radially laminating these unit cylinders 7 so that the central lines are consistent with each other. FIG. 7 is a perspective view showing the central enclosure 11 formed by laminating the unit cylinders 7. When configuring the central enclosure 11 as described above, it is possible to change the permittivity ∈ᵣ as shown in FIG. 2 while maintaining the permittivity ∈_{θ} at a constant value as the permittivity inside the central enclosure 11.

When many unit cylinders 7 is laminated in a concentric shape, the number of laminated unit cylinders 7 may be at least 10 or more. As the number of laminated unit cylinders is increased by decreasing a thickness of one unit cylinder 7, the distribution of the permittivity ∈ᵣ may be accurately approximated as shown in FIG. 2. When the number of laminated unit cylinders 7 is too small, the approximation of the distribution of the permittivity ∈ᵣ becomes insufficient, and therefore the invisible characteristics of the invisible enclosure become worse. Further, the thickness of one unit cylinder 7 may preferably be sufficiently smaller than the wavelength of the electromagnetic wave that is in a range for the invisible characteristics. Practically, it may preferably be 1/10 of a wavelength or less.

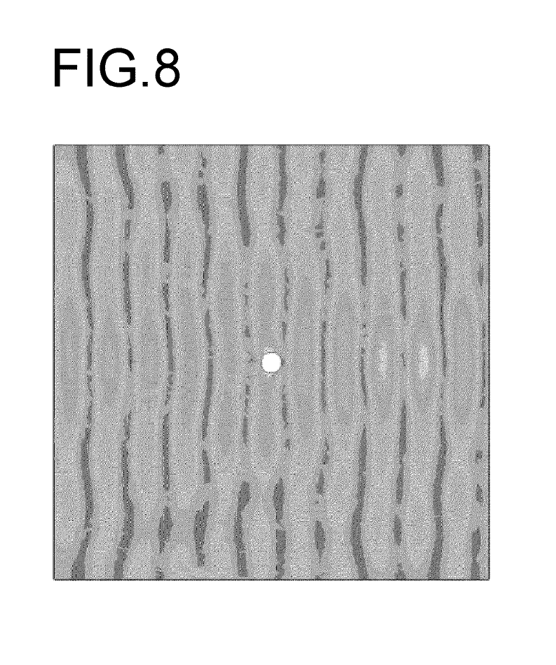

Next, the invisible characteristics of the invisible enclosure were confirmed by a numerical simulation. The numerical simulation was calculated by computer software that executes an electromagnetic field simulation based on a finite element method. First, FIG. 8 shows a scattering state of an electromagnetic wave (plane wave) by a metal rod when the invisible enclosure is not used. A white circular portion at the center is a metal rod and the electromagnetic wave (plane wave) is incident in a left direction from the right of FIG. 8. As shown in FIG. 8, the scattering wave appears forward and backward and the complex scattering state appears due to the interference between the scattering wave and the incident wave.

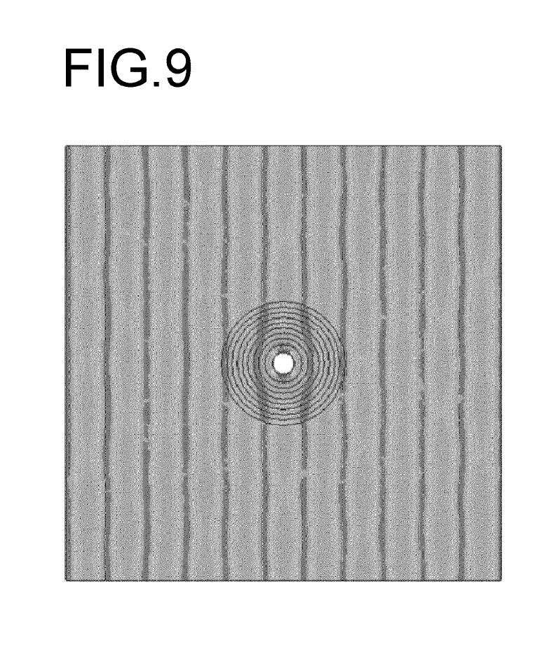

Next, FIG. 9 shows the state of the electromagnetic wave when the invisible enclosure is disposed around the metal rod. A white circular portion at the center is a metal rod and a multi-layered ring-shaped portion around the metal rod is the central enclosure. The entire exterior of the central enclosure is the outer shell. As shown in FIG. 9, when the invisible enclosure is disposed, the incident electromagnetic wave (plane wave) is little disturbed and passes through the metal rod, and then becomes to the plane wave again. That is, it is shown that the metal rod is invisible in the electromagnetic wave.

In the invisible enclosure as described above, the distribution of the permittivity and the permeability as shown in Formula 3 and FIG. 2 is in the condition that a direction of a magnetic field of the incident electromagnetic wave is a z-axis direction. That is, the invisible enclosure as described above may be applied to the incident wave of which the direction of the magnetic field is the z-axis direction. In this case, the invisible characteristics appear.

However, even when a direction of an electric field of the incident wave is the z-axis direction, the invisible enclosure can be configured by a similar method to the method for the invisible enclosure as described above. When the direction of the electric field of the incident wave is the z-axis direction, the propagation of the electromagnetic wave is associated with only the ∈_{z}, μᵣ, and μ_{θ}. Further, the distribution of the permittivity and the permeability is the same as the distribution in which the permittivity ∈ and the permeability μ in the distribution as shown in Formula 3 and FIG. 2 are exchanged with each other. That is, the permittivity ∈_{z} in the z-axis direction and the permeability μ_{θ} in the θ direction inside the central enclosure are constant and the permeability μᵣ in the r direction has a distribution that increases from the inner circumference to the outer circumference.

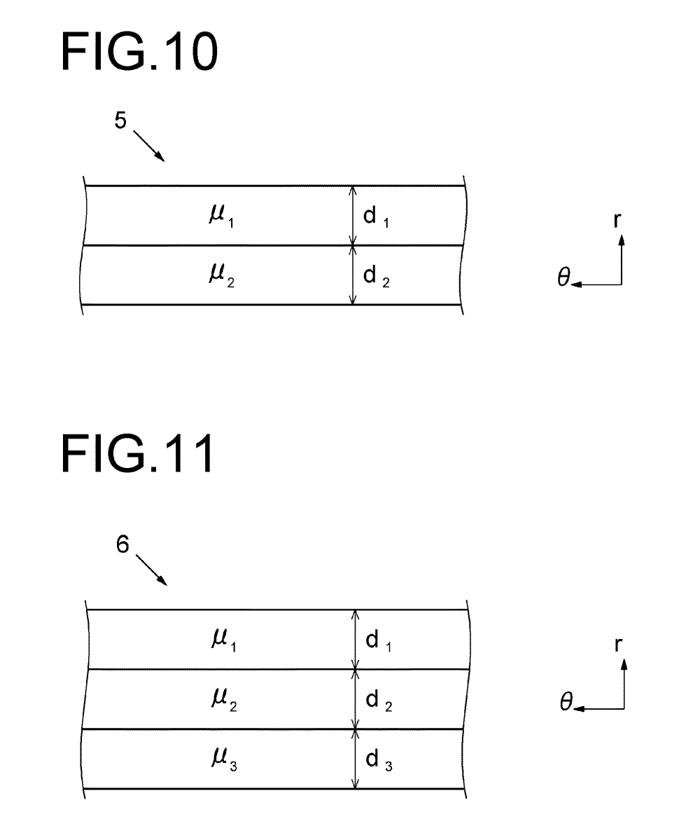

Further, like FIGS. 4 and 5, the layered film having the permeability shown in FIGS. 10 and 11 will be considered. FIG. 10 shows a layered film 5 having a two-layer structure of two kinds of magnetic materials having different permeabilities and FIG. 11 is a layered film 6 having a three-layer structure of three kinds of magnetic materials having different permeabilities. Herein, the direction in which the plurality of layers is stacked is referred to as the radius r direction of the central enclosure 11 and the direction orthogonal to the radius r direction is referred to as the azimuth θ direction.

The layered film 5 of FIG. 10 is formed by laminating the layer having the permeability μ₁ and the thickness d₁ and the layer having the permeability μ₂ and the thickness d₂. In the layered film 5, the effective permeability μᵣ(eff) in the r direction and the effective permeability μ_{θ}(eff) in the θ direction may be calculated by the following formulae.

(d₂+d₂)/μᵣ(eff)=d₂/μ₁+d₂/μ₂

(d₁+d₂)μ_{θ}(eff)=d₁μ₂+d₂μ₂

It is possible to change the permeability μᵣ(eff) while maintaining the permeability μ_{θ}(eff) at a constant value by changing the permeabilities μ₁ and μ₂ and the thicknesses d₁ and d₂ of the layered film 5. Further, even if one permeability (for example, permeability μ₁) is a constant value (for example, permittivity of air), it is possible to change the permeability μᵣ(eff) while maintaining the permeability μ_{θ}(eff) at a constant value. Even for the thicknesses d₁ and d₂, more conditions may be added. For example, the overall thickness of the layered film 3 may be constant.

The layered film 6 of FIG. 11 is formed by laminating the layer having the permeability μ₁ and the thickness d₁, the layer having the permeability μ₂ and the thickness d₂, and the layer having the permeability μ₃ and the thickness d₃. It is possible to change the permeability μᵣ while maintaining the permeability μ_{θ} at a constant value by changing the permeabilities μ₁, μ₂, and μ₃ and the thicknesses d₁, d₂, and d₃ of the layered film 6.

As shown, the layered film 6 of FIG. 11 is formed by stacking the layer having the permeability μ₁ and the thickness d₁, the layer having the permeability μ₂ and the thickness d₂, and the layer having the permeability μ₃ and the thickness d₃. In the layered film 6 having a three-layer structure, the effective permeability μᵣ(eff) in the r direction and the effective permeability μ_{θ}(eff) in the θ direction may be calculated by the following formulae.

(d₁+d+d₃)/μᵣ(eff)=d₁/μ₁+d₂/μ₂+d₃/μ₃

(d₁+d+d₃)μ_{θ}(eff)=d₁μ₁+d₂μ₂+d₃μ₃

It is possible to change the permeability μᵣ(eff) while maintaining the permeability μ_{θ}(eff) at a constant value by changing the permeabilities μ₁ to μ₃ and the thicknesses d₁ to d₃ of the layered film 6. Further, it is possible to change the permeability μᵣ(eff) while maintaining the permeability μ_{θ}(eff) at a constant value by changing only the thicknesses d₁ to d₃ without changing the permeabilities of all the layers. Even for the thicknesses d₁ to d₃, more conditions may be added. For example, the overall thickness of the layered film 6 may be constant.

In the case of the layered film 6, it is possible to relatively simply realize the necessary permeability distribution by changing only the thicknesses of each layer without changing the permeabilities of each layer. The manufacturing cost of the invisible enclosure 1a may be reduced by changing only the thicknesses of each layer.

In addition, like the layered film shown in FIGS. 10 and 11, it is possible to change the permeability μᵣ(eff) while maintaining the permeability μ_{θ}(eff) at a constant value, by changing the permittivities and the thicknesses of each layer even in the case of the multi-layered film having more layers. The unit cylinder is formed by forming the layered film 5 having a two-layer structure, the layered film 6 having a three-layer structure, and the multi-layered film having more layers in a cylindrical shape.

Further, when the central enclosure 11 is formed of a large number of unit cylinders adjusted by changing the permeability μᵣ(eff), it is possible to change and adjust the permeability μᵣ as the permeability inside the central enclosure 11 while maintaining the permeability μ_{θ} at a constant value. When using the central enclosure 11, the invisible enclosure can be configured in the case in which the direction of the electric field of the incident wave is the z-axis direction.

Next, another embodiment of the present invention will be described. In the cylindrical coordinate system (r, θ, z) based on the radius r, the azimuth θ, and the position z in a z-axis direction, various coordinate transformations may be considered in addition to the coordinate transformation (linear transformation) based on the above Formula 1 so as to transform the region in which 0≦r≦b into the ring-shaped region (r′, θ′, z′) in which a≦r′≦b. For example, a coordinate transformation (quadratic transformation) based on the following Formula 4 may be considered.

$${r}^{′} = a + \frac{b - a}{{b}^{2}} {r}^{2} , {θ}^{′} = θ , {z}^{′} = z \qquad [ Formula 4 ]$$

By the coordinate transformation based on Formula 4, each element of the permittivity tensor and the permeability tensor becomes as shown in following Formula 5. However, in order to simplify the representation of the formula, the coordinate system (r′, θ′, z′) is changed to be reset to the coordinate system (r, θ, z). Meanwhile, a subscript represents elements of the coordinate direction and each element is represented by relative permittivity and relative permeability.

$${ɛ}_{r} = {μ}_{r} = \frac{2 ( r - a )}{r} , {ɛ}_{θ} = {μ}_{θ} = \frac{r}{2 ( r - a )} , \\ {ɛ}_{z} = {μ}_{z} = \frac{{b}^{2}}{2 r ( b - a )} \qquad [ Formula 5 ]$$

In the cylindrical coordinate system (r, θ, z), a coordinate transformation (½ order transformation) based on the following Formula 6 may be considered in order to transform the region in which 0≦r≦b into the ring-shaped region (r′, θ′, z′) in which a≦r′≦b.

$${r}^{′} = a + \frac{b - a}{{b}^{1 / 2}} {r}^{1 / 2} , {θ}^{′} = θ , {z}^{′} = z \qquad [ Formula 6 ]$$

By the coordinate transformation based on Formula 6, each element of the permittivity tensor and the permeability tensor becomes as shown in following Formula 7. However, in order to simplify the representation of the formula, the coordinate system (r′, θ′, z′) is changed to be reset to the coordinate system (r, θ, z). Meanwhile, a subscript represents elements of the coordinate direction and each element is represented by relative permittivity and relative permeability.

$${ɛ}_{r} = {μ}_{r} = \frac{r - a}{2 r} , {ɛ}_{θ} = {μ}_{θ} = \frac{2 r}{r - a} , \\ {ɛ}_{z} = {μ}_{z} = 2 {b}^{2} \frac{{( r - a )}^{3}}{{( b - a )}^{4}} \qquad [ Formula 7 ]$$

In the cylindrical coordinate system (r, θ, z), a coordinate transformation (hyperbolic transformation) based on the following Formula 8 may be considered in order to transform the region in which 0≦r≦b into the ring-shaped region (r′, θ′, z′) in which a≦r′≦b.

$${r}^{′} = \sqrt{{a}^{2} + \frac{{b}^{2} - {a}^{2}}{{b}^{2}} {r}^{2}} , {θ}^{′} = θ , {z}^{′} = z \qquad [ Formula 8 ]$$

By the coordinate transformation based on Formula 8, each element of the permittivity tensor and the permeability tensor becomes as shown in the following Formula 9. However, in order to simplify the representation of the formula, the coordinate system (r′, θ′, z′) is changed to be reset to the coordinate system (r, θ, z). Meanwhile, a subscript represents elements of the coordinate direction and each element is represented by relative permittivity and relative permeability.

$${ɛ}_{r} = {μ}_{r} = \frac{{r}^{2} - {a}^{2}}{{r}^{2}} , {ɛ}_{θ} = {μ}_{θ} = \frac{{r}^{2}}{{r}^{2} - {a}^{2}} , \\ {ɛ}_{z} = {μ}_{z} = \frac{{b}^{2}}{{b}^{2} - {a}^{2}} \qquad [ Formula 9 ]$$

Like the case in which the ring-shaped region by the medium represented by the above Formula 2 has the complete invisible characteristics, the ring-shaped region by the media represented by the foregoing Formulae 5, 7, and 9 also has the complete invisible characteristics. However, since so many elements are changed depending on the radius r among the elements of the permittivity tensor and the permeability tensor, the media represented by Formulae 2, 5, and 7 can hardly realize the values of the elements. Herein, the spotlighted medium is the medium represented by Formula 9. In the medium of Formula 9, the permittivity ∈_{z} and the permeability μ_{z} are set as the constant value regardless of the value of the radius r.

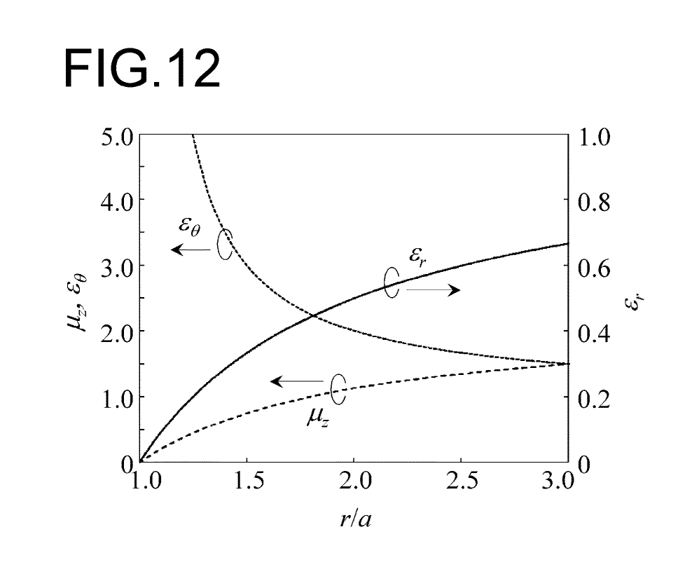

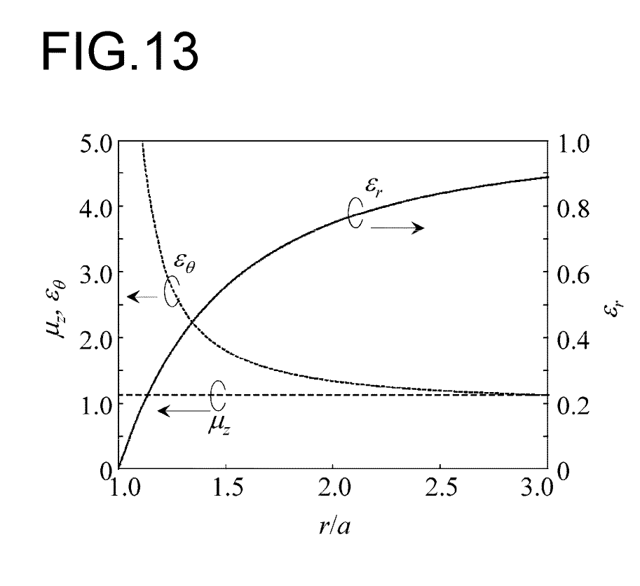

The distribution of the permittivity ∈ᵣ, the permittivity ∈_{θ}, and the permeability μ_{z} of the medium represented by Formula 9 are compared with those of other media in a graph. For example, in the medium represented by Formula 2, the permittivity ∈ᵣ the permittivity ∈_{θ}, and the permeability μ_{z} become a distribution as shown in FIG. 12. On the other hand, in the medium represented by Formula 9, the permittivity ∈ᵣ, the permittivity ∈_{θ}, and the permeability μ_{z} become a distribution as shown in FIG. 13. FIGS. 12 and 13 show the case in which a ratio of the inner diameter to the outer diameter a:b=1:3. A horizontal axis represents a value of r/a and a vertical axis represents the relative permittivity and the relative permeability. In FIG. 13, the permeability μ_{z} becomes a constant value regardless of the value of the radius r.

That is, in the medium of Formula 9, when the direction of the magnetic field of the incident electromagnetic wave is the z-axis direction, the invisible characteristics are realized by adjusting the permittivity ∈ᵣ and the permittivity ∈_{θ} depending on the radius r to be distributed as shown in FIG. 13. The distribution is made inside the central enclosure so that the permeability μ_{z} in the z-axis direction is constant, the permittivity ∈_{θ} in the θ direction is reduced from the inner circumference to the outer circumference, and the permittivity ∈ᵣ in the r direction is increased from the inner circumference to the outer circumference. In order to realize the medium represented by Formula 9, the layered film as shown in FIGS. 4 and 5 may be used.

It is possible to change the permittivities ∈_{θ}(eff) and ∈ᵣ(eff) by using the layered film shown in FIGS. 4 and 5 or the multi-layered film having more layers and changing the permittivity and thickness of each layer. The unit cylinder is formed by forming these layered films in the cylindrical shape and the central enclosure 11 is configured by laminating a large number of unit cylinders. By this configuration, it is possible to realize the invisible characteristics by changing and adjusting the permittivity ∈_{θ} and the permittivity ∈ᵣ inside the central enclosure 11 as shown in FIG. 13.

In the medium of Formula 9, when the direction of the electric field of the incident electromagnetic wave is the z-axis direction, the propagation of the electromagnetic wave is associated with only ∈_{z}, μᵣ, and μ_{θ}. When the distribution of the permittivity and the permeability is the same as the distribution in which the permittivity ∈ and the permeability μ in the distribution as shown in FIG. 13 are exchanged with each other, it is possible to realize the invisible characteristics. That is, the distribution is made inside the central enclosure so that the permittivity ∈_{z} in the z-axis direction is constant, the permeability μ_{θ} in the θ direction is reduced from the inner circumference to the outer circumference, and the permeability μᵣ in the r direction is increased from the inner circumference to the outer circumference. In this case, the layered film as shown in FIGS. 10 and 11 may be used.

As described above, it is possible to form the invisible enclosure by the simple structure of ordinary media materials, without using the medium using the resonance phenomenon or the metamaterials having the complex structure. Further, the invisible characteristics based on the configuration were also confirmed by the electromagnetic field simulation. The invisible enclosure according to the present invention can realize the invisible characteristics in a extremely wider band than a conventional art since the invisible enclosure does not use the resonance phenomenon. According to the present invention, it is possible to provide the broadband and low-loss invisible enclosure. Further, a building or the like can be covered by the invisible enclosure to prevent radio interference or any structure can be covered by the invisible enclosure to prevent electromagnetic waves from being scattered due to the structure.

Further, in the invisible enclosure according to the present invention, a case in which the reflection of the electromagnetic wave occurs at the boundary surface between the outer field and the outer shell due to disposing outer shell may be considered. In this case, the anti-reflection treatment such as the multi-layer coating may be performed on the boundary surface of the outer shell. Further, in realizing the invisible enclosure in liquid or solid, the liquid or the solid itself may work as the outer shell.

### INDUSTRIAL APPLICABILITY

According to the present invention, it is possible to realize the broadband and low-loss invisible enclosure, by the simple structure of ordinary media materials. Further, a building or the like can be covered by the invisible enclosure to prevent radio interference, or any structure can be covered by the invisible enclosure to prevent electromagnetic waves from being scattered due to the structure.

### EXPLANATION OF REFERENCE NUMERALS

1, 1a Invisible enclosure
2 Outer shell
3, 4, 5, 6 Layered film
7 Unit cylinder
10 Cavity
11 Cylindrical central enclosure

1. An invisible enclosure, comprising:
a cylindrical central enclosure (11) having a cavity (10) formed therein; and
an outer shell (2) disposed to enclose an outside of the central enclosure (11),
with an object in the cavity (10) and the central enclosure (11) itself being substantially invisible with an electromagnetic wave, wherein
the central enclosure (11) is formed by laminating a large number of cylindrical layered films formed by radially laminating a plurality of materials having different permittivities so that central lines of the layered films are common, and
effective values of respective elements of permittivity tensors of respective parts of the central enclosure (11) are adjusted by adjusting permittivities and radial thicknesses of respective layers of the layered films along a distance from the central line of the central enclosure (11), that is, a radius.

2. The invisible enclosure according to claim 1, wherein
the radial element of the permittivity tensor is set to be a value sequentially increasing along a radius from the innermost circumference of the central enclosure (11) to the outermost circumference thereof and is set to be a predetermined value smaller than the permittivity of the outer shell (2) at the outermost circumference thereof, and
the circumferential element of the permittivity tensor is set to be a substantially constant value.

3. The invisible enclosure according to claim 2, wherein the layered film is a double-layered film configured of two layers, and permittivity of one of the two layers is set to be a constant value.

4. The invisible enclosure according to claim 2, wherein the layered film is a triple-layered film configured of three layers, and with permittivities of the three layers being set to be a constant value, thicknesses of the three layers are adjusted.

5. The invisible enclosure according to claim 1, wherein
the radial element of the permittivity tensor is set to be the value sequentially increasing along a radius from the innermost circumference of the central enclosure (11) to the outermost circumference thereof and is set to be a predetermined value smaller than the permittivity of the outer shell (2) at the outermost circumference thereof, and
the circumferential element of the permittivity tensor is set to be a value sequentially reducing along the radius from the innermost circumference thereof to the outermost circumference thereof.

6. An invisible enclosure, comprising:
a cylindrical central enclosure (11) having a cavity (10) formed therein; and
an outer shell (2) disposed to enclose an outside of the central enclosure (11),
with an object in the cavity (10) and the central enclosure (11) itself being substantially invisible with an electromagnetic wave, wherein
the central enclosure (11) is formed by laminating a large number of cylindrical layered films formed by radially laminating a plurality of materials having different permeabilities so that central lines of the layered films are common, and
effective values of respective elements of permeability tensors of respective parts of the central enclosure (11) are adjusted by adjusting permeabilities and radial thicknesses of respective layers of the layered films along a distance from the central line of the central enclosure (11), that is, a radius.

7. The invisible enclosure according to claim 6, wherein
the radial element of the permeability tensor is set to be a value sequentially increasing along a radius from the innermost circumference of the central enclosure (11) to the outermost circumference thereof and is set to be a predetermined value smaller than the permeability of the outer shell (2) at the outermost circumference thereof, and
the circumferential element of the permeability tensor is set to be a substantially constant value.

8. The invisible enclosure according to claim 7, wherein the layered film is a double-layered film configured of two layers, and permeability of one of the two layers is set to be a constant value.

9. The invisible enclosure according to claim 7, wherein the layered film is a triple-layered film configured of three layers, and with permeabilities of the three layers being set to be a constant value, thicknesses of the three layers are adjusted.

10. The invisible enclosure according to claim 6, wherein
the radial element of the permeability tensor is set to be the value sequentially increasing along a radius from the innermost circumference of the central enclosure (11) to the outermost circumference thereof and is set to be a predetermined value smaller than the permeability of the outer shell (2) at the outermost circumference thereof, and
the circumferential element of the permeability tensor is set to be a value sequentially reducing along the radius from the innermost circumference thereof to the outermost circumference thereof.

11. The invisible enclosure according to claim 1, wherein the outer shell (2) is formed of homogenous materials.

12. The invisible enclosure according to claim 2, wherein the outer shell (2) is formed of homogenous materials.

13. The invisible enclosure according to claim 3, wherein the outer shell (2) is formed of homogenous materials.

14. The invisible enclosure according to claim 4, wherein the outer shell (2) is formed of homogenous materials.

15. The invisible enclosure according to claim 5, wherein the outer shell (2) is formed of homogenous materials.

16. The invisible enclosure according to claim 6, wherein the outer shell (2) is formed of homogenous materials.

17. The invisible enclosure according to claim 7, wherein the outer shell (2) is formed of homogenous materials.

18. The invisible enclosure according to claim 8, wherein the outer shell (2) is formed of homogenous materials.

19. The invisible enclosure according to claim 9, wherein the outer shell (2) is formed of homogenous materials.

20. The invisible enclosure according to claim 10, wherein the outer shell (2) is formed of homogenous materials.
